(19) United States
(12) Patent Application Publication
(10) Pub. No.: US 2008/0296386 A1
(43) Pub. Date: Dec. 4, 2008

(54) Scan engine interface

(75) Inventors: Bradley S. Carlson, Huntington, NY (US); Thomas D. Bianculli, Manorville, NY (US); Christopher Brock, Manorville, NY (US); Thomas Lackemann, Sayville, NY (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: SYMBOL TECHNOLOGIES, INC., Holtsville, NY (US)

(21) Appl. No.: 11/807,746

(22) Filed: May 30, 2007

(51) Int. Cl. G06K 7/10

(52) U.S. Cl. 235/462.41

(57) ABSTRACT

A scan engine (52, 66) for imaging a target object (30) comprises a photosensitive circuitry (58, 76) located within the scan engine (52, 66) for capturing an image reflected from a target object (30) to the scan engine (52, 66). A communication interface (60, 78) is disposed within the scan engine (52, 66) and coupled to the photosensitive circuitry (58, 76) for communicating an undecoded signal (62, 80) to a remote device (14) over a digital serial interface.

### FIELD OF THE INVENTION

The present invention relates to an imaging system interface, and more particularly, an interface in communication with an indicia imager scan engine and a host controller.

### BACKGROUND OF THE INVENTION

Various electro-optical systems have been developed for reading optical indicia, such as bar codes. A bar code is a coded pattern of graphical indicia comprised of a series of bars and spaces having differing light reflecting characteristics. The pattern of the bars and spaces encode information. In certain bar codes, there is a single row of bars and spaces, typically of varying widths. Such bar codes are referred to as one dimensional (1D) bar codes, and are commonly scanned and decoded by a laser-based flying spot bar code scanner. Other bar codes include multiple rows of bars and spaces, each typically having the same width. Such bar codes are referred to as two dimensional (2D) bar codes. The scanning of 2D bar codes requires an image of the barcode for analysis and are commonly read using imaging-based bar code readers.

The reading of the reflected bar code imaged by either the laser-based bar code scanner or imaging-based bar code reader is achieved by a scan engine located within the reader or scanner. Bar code readers and scanners not only image the bar code or target object, but may also decode the image within the scan engine or via an external decoder. The typical undecoded imaging scan engine interface to a host processor is a high-speed (8) bit parallel interface which is prone to many adverse results. For example, the high-speed (8) bit parallel requirements of the undecoded signal present limitations on the length of the connection between the engine and the host processor. Additionally, the undecoded signal generates electro-magnetic interference (EMI) and noise, degrading the undecoded signal transmission to the host processor and exceeding the accepted limits of emitted radiation. Non-signal related problems also arise in the transmission of an undecoded signal. For example, the owner of the host processor would have to develop its own custom image acquisition system interface for receiving the undecoded signal from the scan engine. In order to prevent the above limitations resulting from the transmission of an undecoded signal from a scan engine, changes to conventional scan engine interface technology is proposed.

### SUMMARY OF THE INVENTION

The present invention relates to a scan engine for imaging a target object comprising photosensitive circuitry located within the scan engine for capturing an image reflected from a target object. The scan engine further includes a communication interface disposed within the scan engine and coupled to the photosensitive circuitry for communicating an undecoded signal to a remote device over a digital interface.

The present invention also relates to a method of communicating an undecoded signal from a scan engine to a remote device by projecting illumination toward a target object from the scan engine such that reflected images are projected back and received by the scan engine. The method further includes focusing the reflected images received by the scan engine through a focusing lens that captures the images on photosensitive circuitry. An undecoded analog signal is produced representative of the images captured on the photosensitive circuitry. The undecoded analog is converted to the digital domain and communicated to a remote device through a serial interface disposed within the scan engine and coupled to the photosensitive circuitry.

The present invention further relates to a scan engine for capturing images of a target object comprising an illumination source located within the scan engine for projecting illumination on a target object. An imaging lens focuses images reflected from the target object received by the scan engine. An imager containing photosensitive elements captures the focused images enhanced by the imaging lens. The imager produces an undecoded signal representative of the captured images. A hardwired serial interface coupled to the imager communicates the undecoded signal to a remote device. The hardwired serial interface is disposed within the scan engine.

The present invention yet further relates to a scan engine for communicating an undecoded signal to a remote device comprising a projecting means for projecting illumination toward a target object from the scan engine such that reflected images are projected back and received by the scan engine. The scan engine further comprises a focusing means for focusing the reflected images received by the scan engine onto photosensitive circuitry that captures the reflected images. An undecoded analog signal representative of the images captured on the photosensitive circuitry is converted to the digital domain and communicated by communication means to a remote device from a serial interface disposed within the scan engine and coupled to the photosensitive circuitry.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a schematic side elevation view of an indicia imager of the present invention;

FIG. 2 is a block diagram illustrating a scan engine used in an imaging-based reader of the prior art;

FIG. 3 is a block diagram illustrating a scan engine used in an imaging-based imager constructed in accordance with one exemplary embodiment of the present invention;

FIG. 4 is a block diagram illustrating a scan engine used in an imaging-based imager constructed in accordance with a second exemplary embodiment of the present invention;

FIG. 5 is a block diagram illustrating a scan engine used in a laser scanner constructed in accordance with one exemplary embodiment of the present invention; and

FIG. 6 is a block diagram illustrating a scan engine used in laser scanner constructed in accordance with a second exemplary embodiment of the present invention.

### DETAILED DESCRIPTION

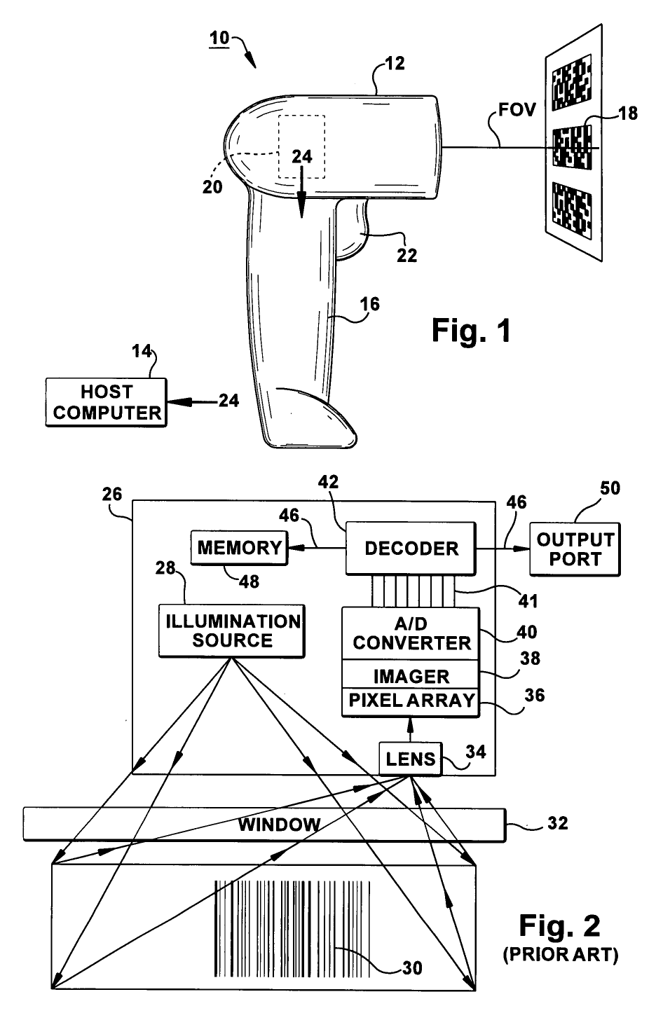

An imaging system 10 includes an indicia imager 12, such as a laser scanner or an imaging-based imager and a host computer 14 as shown schematically in FIG. 1. The indicia imager 12, in addition to imaging both 1D and 2D bar codes and postal codes, is also capable of capturing images and signatures. In one exemplary embodiment of the present invention, the indicia imager 12 is a hand held portable imager supported in a housing 16 that can be carried and used by a user walking or riding through a store, warehouse, or plant for imaging bar codes for stocking and inventory control purposes.

However, it should be recognized that the imaging system 10 of the present invention, to be explained below, may be advantageously used in connection with any type of laser scanner or imaging device, be it portable or stationary. It is the intent of the present invention to encompass all such scanners and imagers.

The indicia imager 12 projects either a laser (laser scanner) or light (imaging-based imager) along the imager's field-of-view (FOV) at a target object 18 such as a bar code. The image is then reflected back toward the indicia imager 12 for imaging by a scan engine 20 internal to the imager. The indicia imager 12 can be automatically enabled or in a continuous enabled state or enabled by engaging by a trigger 22 that initiates the projection of the light or laser that is directed by a user toward the target object 18. Imaging information 24, such as the reflected image relating to the target object 18 is imaged by the scan engine 20 and communicated to the processor or host computer 14 (as will be further discussed below).

FIG. 2 illustrates a scan engine 26 of the prior art associated with an imaging-based reader. The scan engine includes an illumination source 28 comprising light emitting diodes (LEDs) directed toward a target object 30, e.g. a target bar code. Light reflected from the target object 30 passes through a window 32 located in the housing of the imaging-based reader containing the scan engine 26 onto a focusing lens 34. The lens 34 focuses the reflected light onto a pixel array 36 of an imager element 38. The imager element 38 includes the imaging pixel array 36 or other photosensitive elements, such as charged coupled device (CCD) array, or complementary metal oxide semiconductor (CMOS) array, which would provide suitable examples. The imager element 38 also includes an analog-to-digital (A/D) converter 40 for converting an analog signal produced by the imager element 38 over to the digital domain.

A bus connection 41 provides a communication link between the imager element 38 and a decoder 42. The bus connection 41 is a high-speed (8) bit parallel interface for providing a digital signal to the decoder 42 representative of the captured image frame. The decoder 42 processes the digitized signals and attempts to decode the target object 30 into decoded information 46. The decoded information 46 is a fraction of the size of the captured image frame sent from the imager element 38 to the decoder 42 along bus 41. As such, the decoded information 46 can easily be stored locally by the scan engine in memory 48 and/or communicated to a scan engine decoder information 46 output port 50.

The high video rate of the captured image data sent from the imager element 38 to the decoder 42, especially for a 2D image requires the bus 41 to be 48 MHz eight (8) bit parallel bus. Typically, the bus 41 is required to transfer 15 to 30 frames per second from the imager element 38. The high speed parallel nature of the bus 41 of FIG. 2 creates several implementation challenges, such as limitations on length of the bus 41 connection and exposure to electro-magnetic emissions (EMI) that can corrupt the imaged signal being transmitted. Thus a relatively short multiple channel interface bus 41 has been required. Further the scan engine 26 of the prior art requires the decoder 42 so that a much smaller decoded signal represented by the decoded information 46 can be sent to a host computer.

Laser scanners of the prior art are similarly constructed to the extent that the signals are reduced and typically decoded by the scanner prior to transmission to a host computer.

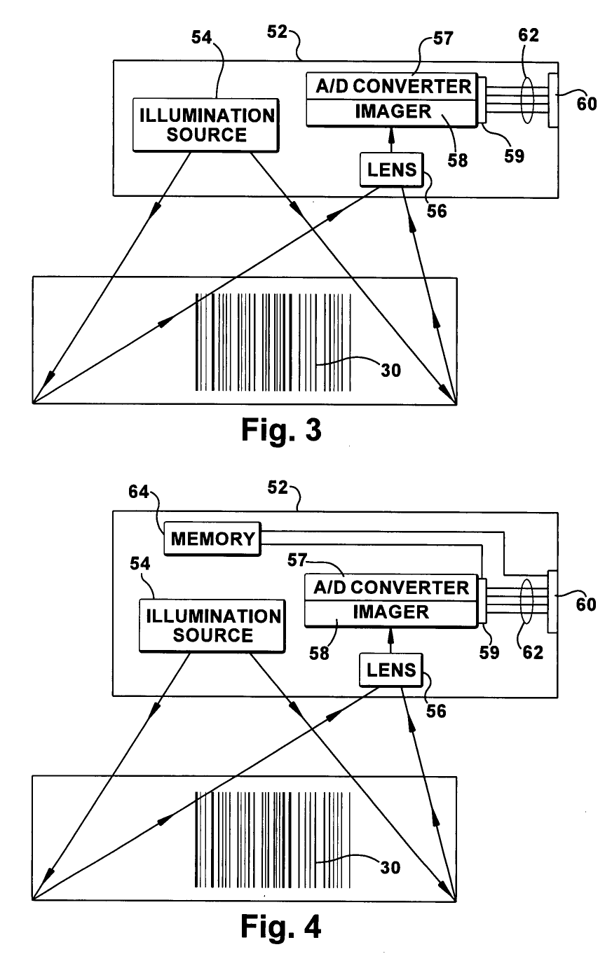

FIG. 3 illustrates one exemplary embodiment of a block diagram of a scan engine 52 constructed in accordance with the present invention for an imaging-based imager. The scan engine 52 includes an illumination source 54 such as an LED or bank of LEDs for projecting light onto the target object 30, such as a bar code. The reflected image is focused by an imaging lens 56 located in the scan engine 52. The focused image is projected onto photosensitive sensors or pixel array (e.g., CMOS or CCD array) located in an imager element 58. The imager element 58 also includes an analog-to-digital (A/D) converter 57 for converting an analog signal produced by the imager element 58 over to a digital domain and discrete circuitry 59, such as an application specific integrated circuit (ASIC). The imager element 58 further includes a communication connection to an imager interface 60. The imager interface 60 provides a connection to the scan engine 52 capable of receiving undecoded captured image information (undecoded signal 62) from the imager element 58. The imager interface 60 can be either integral to the imager element 58 or remotely located within the scan engine 52. The discrete circuitry 59 allows the undecoded signal 62 to be compatible with the particular type of imager interface 60.

In one exemplary embodiment, the imager interface 60 connection to the scan engine 52 is capable of transmitting the undecoded signal 62 at 15-30 frames per second in real-time images produced by the imager element 58 to a host computer 14 several feet away. In another exemplary embodiment, the scan engine 52 includes an imager element 58 that is a 1.3 mega pixel (Mpixel) imager that transmits 30 frames per second that equates to 384 Mbits/sec bandwidth for (8) bit images as the undecoded signal 62 provided from the imager interface 60. The host computer 14 associated with the illustrated exemplary embodiment of FIG. 3 would have its own decode software for decoding the undecoded signal 62 on the host computer's own platform. This advantageously reduces the complexity of interfacing the scan engine 52 to host computers 14. The imager interface 60 in addition to connecting to the host computer 14 can also communicate to any other type of peripheral, computer network, or the like without departing from the spirit and scope of the claimed invention

FIG. 4 illustrates another exemplary embodiment of a block diagram of a scan engine 52 constructed in accordance with the present invention for an imaging-based imager. The operation of the illustrated exemplary embodiment of FIG. 4 is similar to that of FIG. 3 with the exception that the scan engine 52 includes the addition of a memory device 64 that would allow the undecoded signal 62 to be stored in for example a buffer, before transmission through the imager interface 60 to a host computer 14 for decoding.

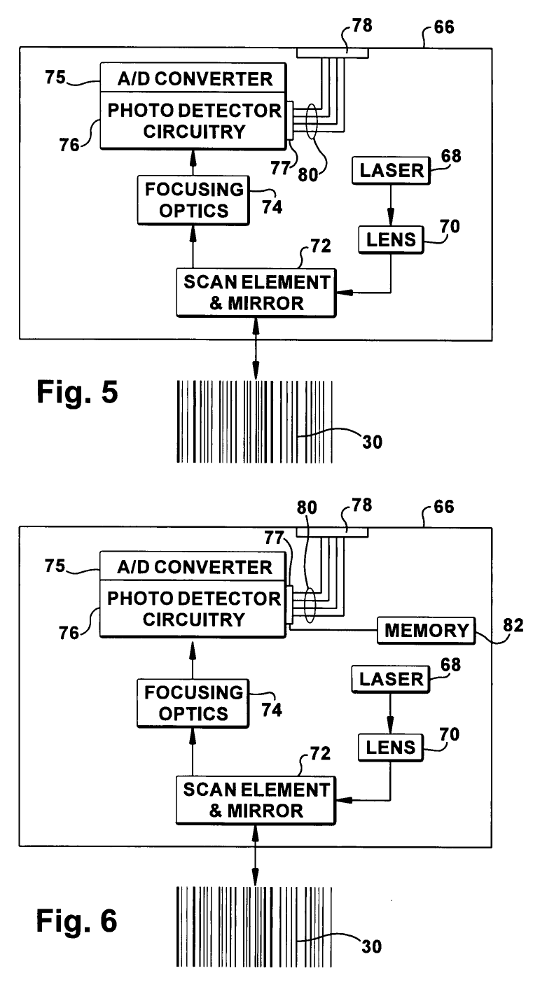

FIG. 5 illustrates a block diagram of a scan engine 66 constructed in accordance with the present invention for a laser scanner. The scan engine 66 includes a laser 68 that generates a laser beam, which is focused by a focusing lens 70. The beam moves in an oscillatory pattern across the target object 30 e.g., bar code by a scan element or mirror assembly 72. Focusing optics 74 focus reflected light from the target object 30 onto photodetector circuitry 76. The photodetector circuitry 76 comprises a photodetector, such as a photodiode, voltage control circuitry such as an automatic gain control circuit (AGC), and a differentiator that functions to differentiate a current output signal of the photodiode, and an analog-to-digital (A/D) converter 75 for converting an analog signal representative of the target image over to a digital domain, generating a digital output representative of the target object 30. Coupled to the photodetector circuitry 76 is a discrete circuit 77 such as an ASIC circuit.

Similar to the exemplary embodiment of FIG. 3, the scan engine 66 of FIG. 5 includes a photodetector interface 78 for transmitting an undecoded signal 80 from the photodetector circuitry 76 to a host computer 14. The photodetector interface 78 can be either integral to the photodetector circuitry 76 or remotely located within the scan engine 66. The discrete circuit 77 allows the undecoded signal 80 to be compatible with the particular type of photodetector interface 78.

The host computer 14 would then on its own software/hardware platform decode the undecoded signal 80 received through the photodetector interface 78. The photodetector interface 78 in addition to connecting to the host computer 14 can communicate to any other type of peripheral, computer network, or the like without departing from the spirit and scope of the claimed invention.

FIG. 6 illustrates another exemplary embodiment of a block diagram of a scan engine 52 constructed in accordance with the present invention for a laser scanner. The operation of the illustrated exemplary embodiment of FIG. 6 is similar to that of FIG. 5 with the exception that the scan engine 66 includes the addition of a memory device 82 that would allow the undecoded signal 80 to be stored in for example a buffer, before transmission through the photodetector interface 78 to a host computer 14 for decoding.

The advent of advancements of serial communication interfaces such as high speed Uniform Serial Bus (USB) allows for the transfer of up to 480 MBits/second in the 2.0 version. A serial connection such as USB would enable a direct connection to the imager interface 60 or photodetector interface 78 for the transfer of the undecoded signal 62, 80, respectively. Further, recent advances in serial communication interfaces enable a higher dynamic range scan engine with the same serial communication interface. This would allow for example, the transferring of more information, 10 bits instead of 8 bits. While USB protocols are discussed, the imager interface can be any type of digital serial interface protocol connection capable of transmitting undecoded signals 62, 80 from scan engines 52, 66 without departing from the spirit and scope of the claimed invention. Further, the undecoded signal 62, 80 can be a power-based signal such as five (5) volts (DC) or an optic-based signal transmitted over a fiber optic serial interface 60, 78. In one exemplary embodiment, the imager interface and/or photodetector interface 60, 78, respectively is a serial interface capable of transferring the undecoded signal 62, 80 to a host computer 14. In another exemplary embodiment, the imager interfaces 60, 78, respectively are adaptable to a USB interface for transmitting the undecoded signal 62, 80 to a host computer 14. In another exemplary embodiment, the interfaces 60, 78 are adaptable to a USB 2.0 Mini B interface. In yet another exemplary embodiment, the interfaces 60, 78 are adaptable to either a male or female type connection capable of transferring the undecoded signals 62, 80. In yet another further exemplary embodiment, the interfaces 60, 78 are adaptable to a differential signaling connection capable of transferring the undecoded signals 62, 80. In another exemplary embodiment the interfaces 60, 78 are adaptable to IEEE 1394 interface often referred to as Apple Inc.'s brand name FIREWIRE® for the IEEE 1394 interface connection capable of transferring the undecoded signals 62, 80.

The interfaces 60 and 78 include in yet another exemplary embodiment, four shielded wires one of the four wires providing a voltage for power to the scan engines 52, 66. The second wire includes a ground for the scan engines. The remaining two wires of the four wire pinout are for data transmission on either a twisted or untwisted pair of wire connections. The undecoded signal 62, 80 transmission in one exemplary embodiment could be half-duplex differential signaling to help reduce EMI and noise and allow for longer line connections between the scan engines 52, 66 and the respective host computer 14.

By eliminating the parallel (8) bit interface circuitry from the scan engines 52, 66 of the present invention, the size of the scan engine of the indicia reader 12 can be advantageously reduced accordingly, along with the costs for parts and fabrication of the scan engines. In addition, the multiple channel bus 41 can be reduced from the typical (8) bit line bus to a 4 to 5 pinout USB type connection. Further the USB connection can act as a source of power and ground to the scan engines 52, 66 and indicia reader 12. The serial interface 60, 78 substantially reduces the length restrictions discussed with the scan engines of the prior art. Furthermore, many host computers can connect natively to USB or IEEE 1394 interfaces without the need for custom circuitry.

In one exemplary embodiment the interfaces 60, 78 are adaptable for receiving communications from the host computer 14. For example, the scan engine 52 and/or imager element 58, receive instructions from the host computer 14 adjusting the exposure time of the imager element 58. Likewise, the scan engine 52 and/or imager element 58 can provide information regarding its current state to the host computer 14 indicating focus position and status of the imager element 58 or digitizer settings of scan engine 52. Further power could be provided from the host computer 14 to the scan engines 52, 66 through the interface 60, 78 for powering the imager element 58, illumination source 54, photodetector circuitry 76, laser 68, and the like.

While the present invention has been described with a degree of particularity, it is the intent that the invention includes all modifications and alterations from the disclosed design falling within the spirit or scope of the appended claims.

Having described the invention, the following is claimed:

1. A scan engine for imaging a target object comprising:
photosensitive circuitry located within the scan engine for capturing an image reflected from a target object to the scan engine;
a communication interface disposed within said scan engine and coupled to said photosensitive circuitry for communicating an undecoded signal to a remote device over a digital serial interface.

2. The scan engine of claim 1 wherein said photosensitive circuitry includes an imager element and pixel array for capturing an image reflected from a target object.

3. The scan engine of claim 1 wherein said photosensitive circuitry includes photodetector components for capturing an image reflected from a laser-based scanner.

4. The scan engine of claim 2 wherein said communication interface is integrally connected to said imager element.

5. The scan engine of claim 2 wherein said communication interface is remotely connected to said imager element.

6. The scan engine of claim 1 wherein said serial interface is compatible with optical data transmission.

7. The scan engine of claim 1 wherein said serial interface is compatible with USB data transmission.

8. The scan engine of claim 1 wherein said serial interface is compatible with IEEE 1394 data transmission.

9. The scan engine of claim 1 wherein said remote device is a host computer.

10. The scan engine of claim 1 wherein said communication interface is constructed to receive instructions from said remote device.

11. The scan engine of claim 1 wherein said communication interface is constructed to receive power from said remote device.

12. The scan engine of claim 1 wherein said communication interface is constructed to transmit status information to said remote device.

13. A method of communicating an undecoded signal from a scan engine to a remote device comprising the steps of:
projecting illumination toward a target object from said scan engine such that reflected images are projected back and received by said scan engine;
focusing said reflected images received by the scan engine through a focusing lens;
capturing the focused images onto photosensitive circuitry;
producing an undecoded signal representative of the images captured on said photosensitive circuitry;
converting the undecoded signal to a digital domain forming an undecoded digital signal; and
communicating said undecoded digital signal to a remote device from a serial interface disposed within said scan engine and coupled to said photosensitive circuitry.

14. A scan engine for capturing images of a target object comprising:
an illumination source located within said scan engine for projecting illumination on a target object;
an imaging lens for focusing images reflected from the target object received by the scan engine;
an imager containing photosensitive elements that captures the focused images enhanced by the imaging lens, the imager producing an undecoded analog signal representative of the captured images that is converted to an undecoded digital signal by a signal converter; and
a hardwired serial interface coupled to said imager for communicating the undecoded digital signal to a remote device, the interface being disposed within said scan engine.

15. The scan engine of claim 14 wherein said hardwired serial interface is integrally connected to said imager.

16. The scan engine of claim 14 wherein said hardwired serial interface is remotely connected to said imager.

17. The scan engine of claim 14 wherein said hardwired serial interface is compatible with USB data transmission.

18. The scan engine of claim 14 wherein said hardwired serial interface is compatible with IEEE 1394 data transmission.

19. The scan engine of claim 14 wherein said hardwired serial interface is compatible with optical data transmission.

20. The scan engine of claim 14 wherein said hardwired serial interface is constructed to receive instructions from said remote device.

21. The scan engine of claim 14 wherein said hardwired serial interface is constructed to transmit status information to said remote device.

22. The scan engine of claim 14 wherein said hardwired serial interface is constructed to receive power from said remote device.

23. A scan engine for communicating an undecoded signal to a remote device comprising:
a projecting means for projecting illumination toward a target object from said scan engine such that reflected images are projected back and received by said scan engine;
a focusing means for focusing the reflected images received by the scan engine onto photosensitive circuitry, capturing the reflected images;
an undecoded signal representative of the images captured on said photosensitive circuitry;
a converting means for altering the undecoded signal to the digital domain to form an undecoded digital signal; and
communication means for communicating said undecoded digital signal to a remote device from a serial interface disposed within said scan and coupled to said photosensitive circuitry.
